(19) United States
(12) Patent Application Publication
(10) Pub. No.: US 2021/0235666 A1
(43) Pub. Date: Aug. 5, 2021

(54) EQUESTRIAN MYOFACIAL BLADE

(71) Applicant: MEGAN WELLES, Buffalo, WY (US)

(72) Inventor: MEGAN WELLES, Buffalo, WY (US)

(21) Appl. No.: 16/779,612

(22) Filed: Feb. 2, 2020

(51) Int. Cl. A01K 13/00

(52) U.S. Cl. CPC A01K 13/002

(57) ABSTRACT

A graspable myofascial blade having a concave edge adapted to contact and release equine back, shoulder and hip musculature.

### FIELD OF THE INVENTION

The present invention relates to a means to massage and achieve facia and myofascial release of tension within the musculature of horses.

### BACKGROUND OF THE INVENTION

Thus, there is a long-felt need to massage the fascia of horses. Such myofascial horse tissue can hold thousands of pounds of pressure in a horse body. When such equine fascia holds tension, the horse suffers decrease range of motion, soreness and decrease equine performance. Specifically, equine are in need of specific massage techniques. Overtime and poor saddle design, many horses become sore in the withers and back from carrying the saddle. Also, current equine tools do not aid the horses that specialize in running events. Such horses become sore in the shoulder and hip area from the large muscle groups that are required to perform at higher levels. A tool is needed to increase equine performance in any equine discipline. While many tools and techniques that are available for humans there are seldomly known and used techniques and tools for horses. A tool is needed to increase the health of horses and enhance equine performance in any equine discipline

### SUMMARY OF THE INVENTION

Accordingly, it is an object of embodiments of the present invention to provide for a liquid container holder apparatus. Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims. To achieve the foregoing and other objects, and in accordance with the purposes of the present invention, as embodied and broadly described herein, the invention comprises a equestrian myofascial blade comprising a plate having a top surface, a bottom surface, a perimeter between the top surface and the bottom surface of the plate, said perimeter comprising a concave edge and a second edge, said second edge opposing said concave edge, and said plate comprising a first cavity and a second cavity, both cavities disposed between said concave edge and said second edge.

Benefits and advantages of the present invention include, but are not limited to providing an equestrian myofascial blade that muscle massages and release muscle tension for equine specimens to aid in equestrian performance and reduce pain.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a top down view of one embodiment of the instant invention depicting an equestrian myofascial blade.

FIG. 2 illustrates a side perspective view of one embodiment of the instant invention depicting an equestrian myofascial blade.

### DETAILED DESCRIPTION OF THE INVENTION AND DRAWINGS

Reference will now be made in detail to embodiments of the invention, examples of which are illustrated in the accompanying drawings. Throughout the following detailed description, the same reference characters refer to the same or similar elements in all figures. In this detailed description, reference is to a few embodiments of the instant invention, as illustrated in the accompanying and above-referenced drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

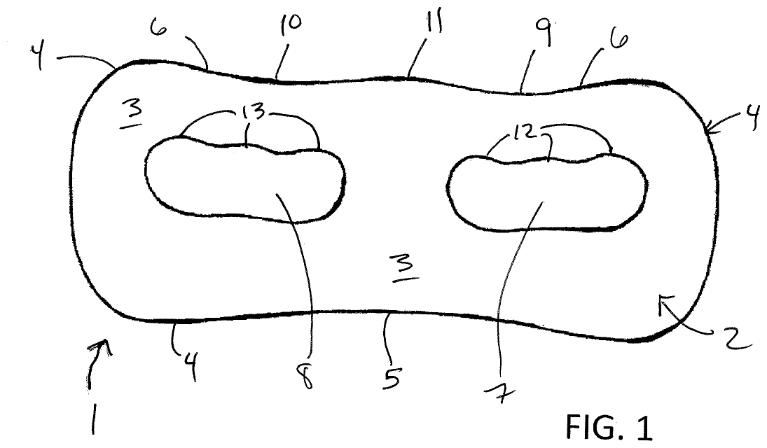

FIG. 1, a top down view of the equestrian myofascial blade, depicts one embodiment of the instant invention comprising an equestrian myofascial blade 1 comprising a plate 2 having a top surface 3, a bottom surface (not depicted, but opposing the top surface), a perimeter 4 between the top surface 3 and the bottom surface of the plate 2. The perimeter 2 comprises a concave edge 5 on one side and an opposing second edge 6 on the other side of the plate 2. The plate 2 comprises a first cavity 7 and a second cavity 8. The first cavity 7 and the second cavity 8 are disposed next to and horizontally relative to each other. Both the first cavity 7 and the second cavity 8 are disposed between the concave edge 5 and the second edge 6.

FIG. 1 depicts the first cavity 7 having graspable finger slots 12 and the second cavity 8 having graspable finger slots 13. The second edge 6 comprises a first concave portion 9, a second concave portion 10 and a convex portion 11 between the second side first concave portion 9 and the second sides second concave portion 10 concave portions on the second side.

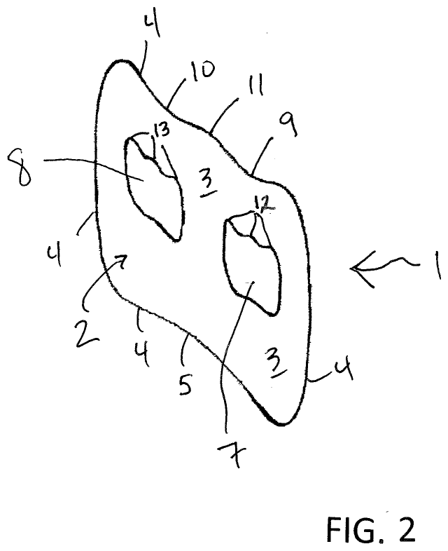

FIG. 2, a side perspective view of the equestrian myofascial blade, depicts one embodiment of the instant invention comprising an equestrian myofascial blade 1 comprising a plate 2 having a top surface 3, a bottom surface (not depicted, but opposing the top surface), a perimeter 4 between the top surface 3 and the bottom surface of the plate 2. The perimeter 2 comprises a concave edge 5 on one side and an opposing second edge 6. The plate 2 comprises a first cavity 7 and a second cavity 8. The first cavity 7 and the second cavity 8 are disposed next to and horizontally relative to each other. Both the first cavity 7 and the second cavity 8 are disposed between the concave edge 5 and the second edge 6.

FIG. 2 depicts the first cavity 7 having graspable finger slots 12 and the second cavity 8 having graspable finger slots 13. The second edge 6 comprises a first concave portion 9, a second concave portion 10 and a convex portion 11 between the second side first concave portion 9 and the second sides second concave portion 10 concave portions on the second side.

The equestrian myofascial blade is adapted to contact equine back, shoulder and hip musculature blade and is different and unique from human what would be necessary to accommodate smaller human musculature. The concave curvature is generally shaped to contact more muscle tissue. The two cavities allow for the horse caregiver to use both hands with some amount of force and alter angles as the concave edge 5 moves down the horse's muscles. The concave edge 5 may be four to ten inches in length to accommodate the larger muscles of the horse.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While this invention has been described in terms of several embodiments, there are alterations, permutations, and equivalents, which fall within the scope of this invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. An equestrian myofascial blade comprising a plate having a top surface, a bottom surface, a perimeter between the top surface and the bottom surface of the plate, said perimeter comprising a concave edge and a second edge, said second edge opposing said concave edge, and said plate comprising a first cavity and a second cavity, both cavities disposed between said concave edge and said second edge.

2. The equestrian myofascial blade of claim 1, wherein the cavities further comprise graspable finger slots.

3. The equestrian myofascial blade of claim 1, wherein said second edge comprises two concave portions and one convex portion between the two said concave portions on the second side.

4. The equestrian myofascial blade of claim 1, wherein said concave edge is adapted to contact equine back, shoulder and hip musculature.

5. The equestrian myofascial blade of claim 1, wherein the concave edge has a length and the length comprises between four and ten inches in length.
